(19) United States
(12) Patent Application Publication
(10) Pub. No.: US 2016/0161953 A1
(43) Pub. Date: Jun. 9, 2016

(54) Mass Flow Controller with Multiple Communication Protocols

(71) Applicants: Joseph Monkowski, Danville, CA (US); William Brisco, San Jose, CA (US); Adam Monkowski, Pleasanton, CA (US)

(72) Inventors: Joseph Monkowski, Danville, CA (US); William Brisco, San Jose, CA (US); Adam Monkowski, Pleasanton, CA (US)

(73) Assignee: PIVOTAL SYSTEMS CORPORATION, Fremont, CA (US)

(21) Appl. No.: 14/558,946

(22) Filed: Dec. 3, 2014

(51) Int. Cl. G05D 7/06; G05B 19/042

(52) U.S. Cl. CPC G05D 7/0635; G05B 19/042

(57) ABSTRACT

A system for utilizing more than one communication protocol on a single mass flow controller (MFC) device. Communication protocols include, but are not limited to, DeviceNet, RS-485, and analog. A D-Subminiature connector (D-Sub) of the MFC has a pin configuration system that is compatible between RS-485 and analog. In addition, a different connector plug is used for DeviceNet on the same MFC, eliminating the need for compatibility of pins with other communication protocols. Together, these above-mentioned configuration systems allow one MFC device to choose between more than one communication protocol.

### BACKGROUND OF THE INVENTION

Embodiments in accordance with the present invention relate generally to communication protocols, and, more specifically, relate to methods and systems that incorporate multiple communication protocols on a single mass flow controller (MFC) device.

A MFC is a device used to measure and control the flow of gases and fluids. A MFC is designed and calibrated to control a specific type of fluid or gas at a particular range of flow rates. The MFC can be given a set-point from 0% to 100% of its full scale flow range.

MFCs are used in several industries. The most precise requirements for MFCs generally come from the semiconductor industry for monitoring and calibrating gas flows for critical manufacturing processes like etch and deposition.

All MFCs have an inlet port, an outlet port, a mass flow sensor and a control valve. The MFC also has an analog-to-digital converter, which takes an analog signal and digitizes it into a binary format. The MFC is fitted with a closed loop control system. This closed loop system receives an input signal/value from the operator (or an external circuit/computer) that it compares to the digitized mass flow sensor value, and adjusts the control valve accordingly to achieve the required flow.

Historically, MFCs only incorporated one communication protocol per device. Initially, the protocol was analog. Next came the RS-485 digital standard. In recent years, DeviceNet has become a popular communication protocol in certain industries. In any case, the customer must maintain separate MFCs for each communication protocol. This invention allows for multiple communication protocols per MFC device, leading to lower inventory costs and simpler operations.

While prior art (e.g. U.S. Patent Application No. 20070094548—Methods and Apparatus for Monitoring Host to Tool Communications, and U.S. Pat. No. 8,102,844—High-speed SECS message services (HSMS) pass-through including bypass) covered secured communications, high-speed message services, and data reporting between various semiconductor tools and wider networks, there is an absence of prior art on the more specific subject of maintaining multiple communication protocols on a single MFC device.

Given the above, there is a need in the art for methods and systems to incorporate multiple communication protocols on a single MFC device.

### BRIEF SUMMARY OF THE INVENTION

Embodiments of the present invention relate to systems for utilizing more than one communication protocol on a single device, including, but not limited to, a mass flow controller (MFC) device.

### BRIEF DESCRIPTION OF THE SEVERAL VIEWS OF THE DRAWING

Table 1 shows the specifications, commentary and layouts which support multiple communication protocols on a single MFC device.

FIG. 1 show the 9-pin D-SUB plug connector pin layout adapted to RS-485 mode.

FIG. 2 show the 9-pin D-SUB plug connector pin layout adapted to analog mode.

FIG. 3 shows the external network connections from the semiconductor fabrication tool that holds the MFC device to external host computer and storage systems.

FIG. 4 shows the signal name and corresponding pin location for the 9-pin D-SUB plug connector.

### DETAILED DESCRIPTION OF THE INVENTION

The following description sets forth the numerous specific details such as examples of specific systems, components, and so forth, in order to provide a good understanding of the embodiments of the present invention. It will be apparent to one skilled in the art, however, that at least some of the present invention may be practiced without these specific details. In other instances, well-known components or systems are not described in detail or are presented in simple block diagram format in order to avoid obscuring the present invention. Consequently, the specific details set forth are merely exemplary. Particular implementations may vary from these exemplary details and still be contemplated to be within the spirit and scope of this description and the appended claims.

The present invention describes a system for utilizing more than one communication protocol on a single MFC device. Communication protocols include, but are not limited to, DeviceNet, RS-485, and analog.

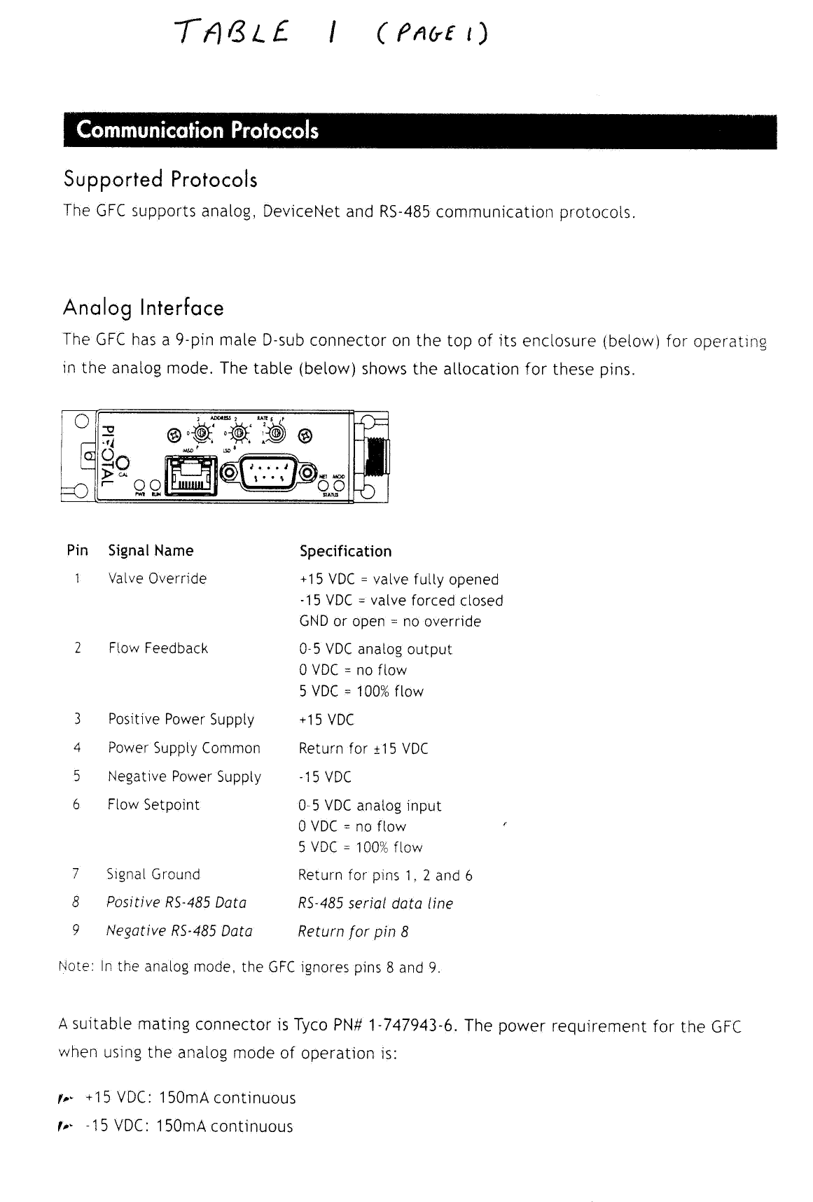

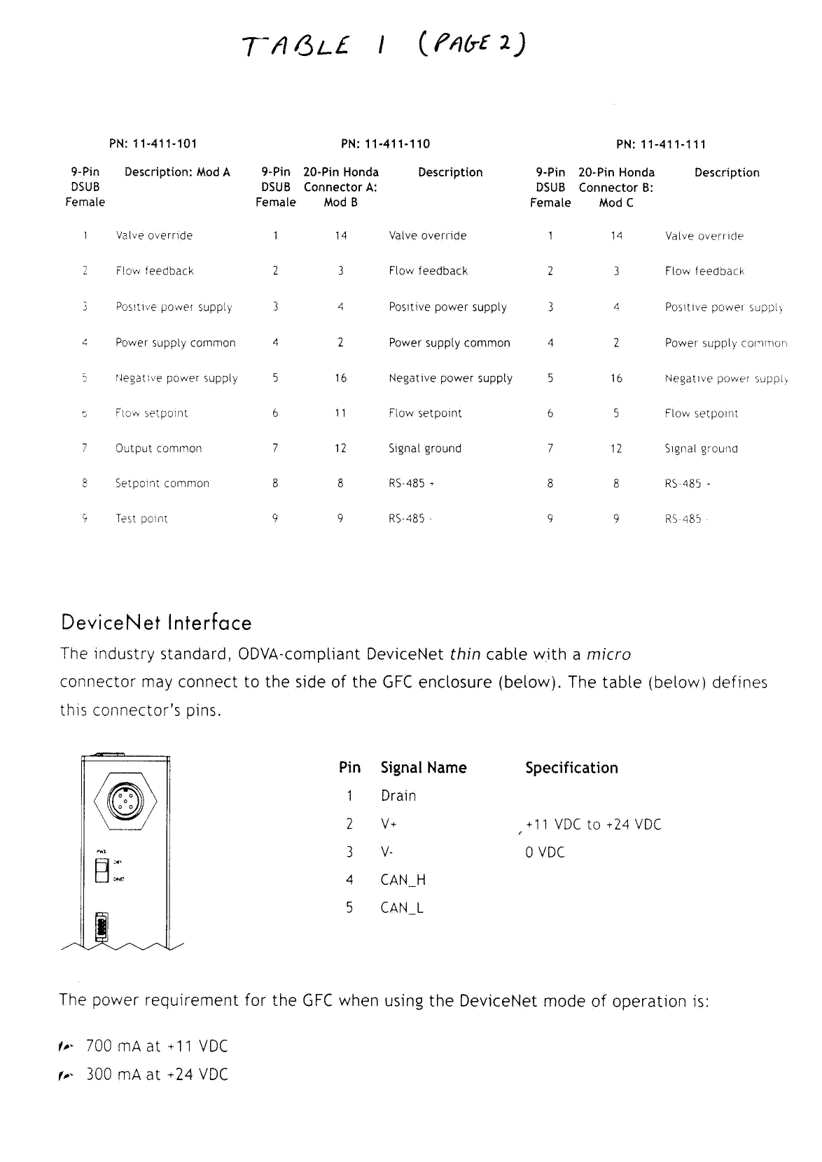

Table 1 provides the specifications, and FIGS. 1 through 4 describe the physical layouts that enable multiple communication protocols on a single MFC device. In some cases, it may be more advantageous to use a digital communication protocol such as RS-485 or DeviceNet. In other cases, it may be more advantageous to use an analog protocol. This invention provides the flexibility to use the optimal communication protocol without having to switch-out a MFC during the semiconductor manufacturing process.

Certain embodiments in accordance with the present invention also include a pin configuration that is compatible between RS-485 and analog protocols, and a different connector plug for DeviceNet that operates independently from other protocols.

An embodiment of a method in accordance with the present invention comprises the following physical layer: an electrical connector of the MFC (in the example in FIG. 1, a 9-pin D-Sub plug connector 100 using a suitable receptor) operating at an appropriate voltage (in the example in Table 1, MFC power of +/−15 VDC). In reference to the allocation of respective 9 pins in FIG. 1, the MFC ignores pins 2 (two) 101 and 6 (six) 102 in RS-485 mode, and communicates via pins 8 and 9.

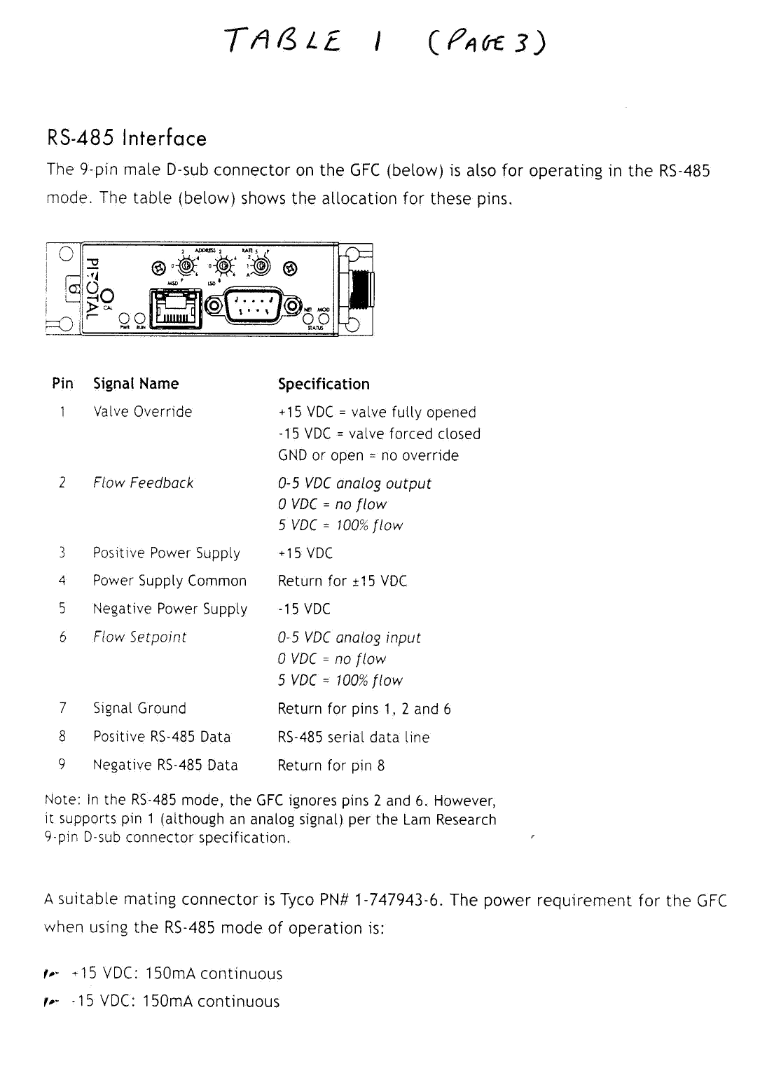

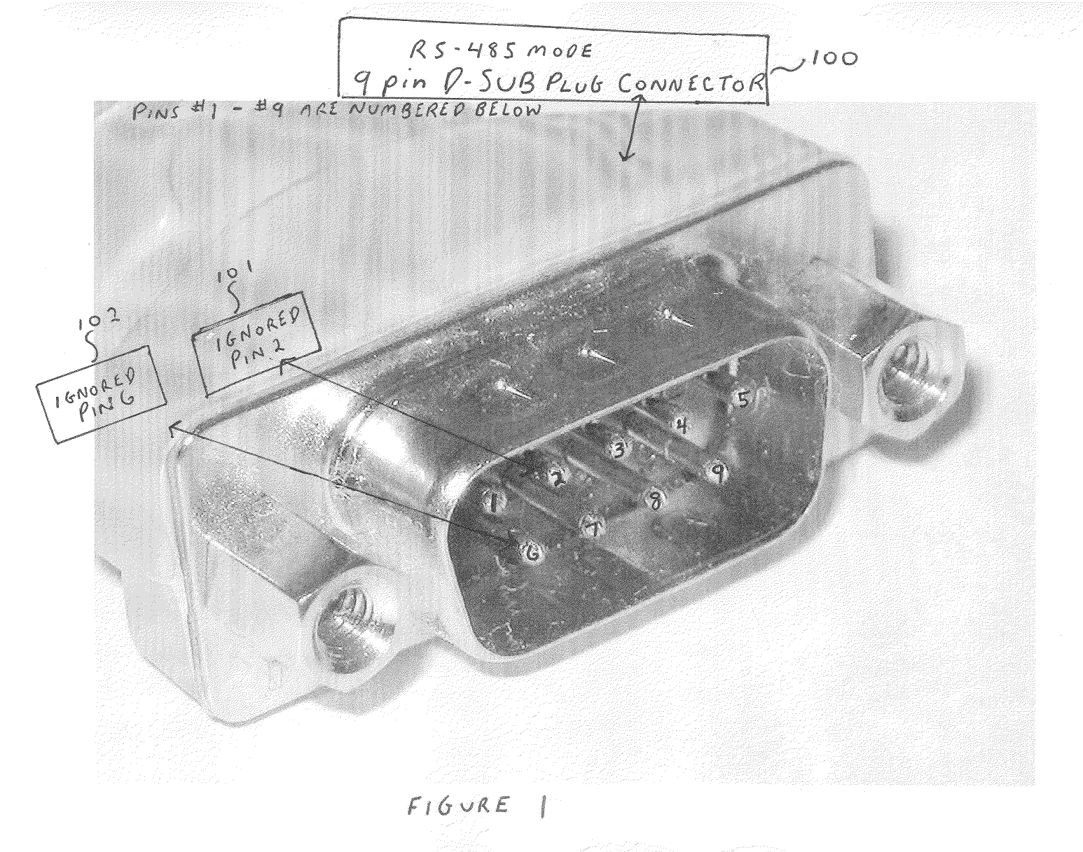

In accordance with certain embodiments, the method may further comprise that in analog mode, an electrical connector of the MFC (in the example in FIG. 2, a nine-pin D-Sub plug connector 110 using a suitable receptor), pin 8 as well as pin 7, are both ground. In this case, an adapter is used to connect pin 8 to pin 7. The MFC allows pin 8 to become ground in this case, making the MFC compatible with certain process tools that require pin 8 to be ground. In reference to the allocation of respective 9 pins in FIG. 2, the MFC allows pin 8 (eight) 111 to be ground and ignores pin 9 (nine) 112 in analog mode.

An embodiment of a system in accordance with the present invention comprises using an Ethernet bridge to provide Ethernet-based network connectivity between the MFC and at least one other entity.

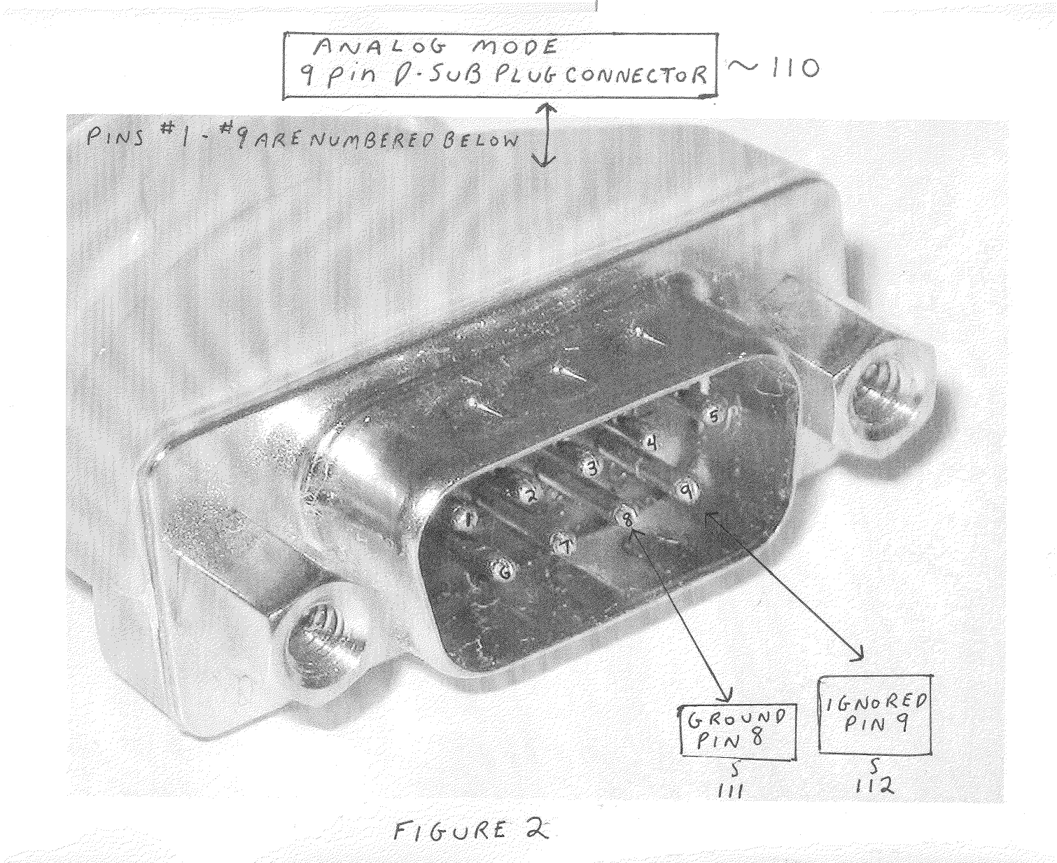

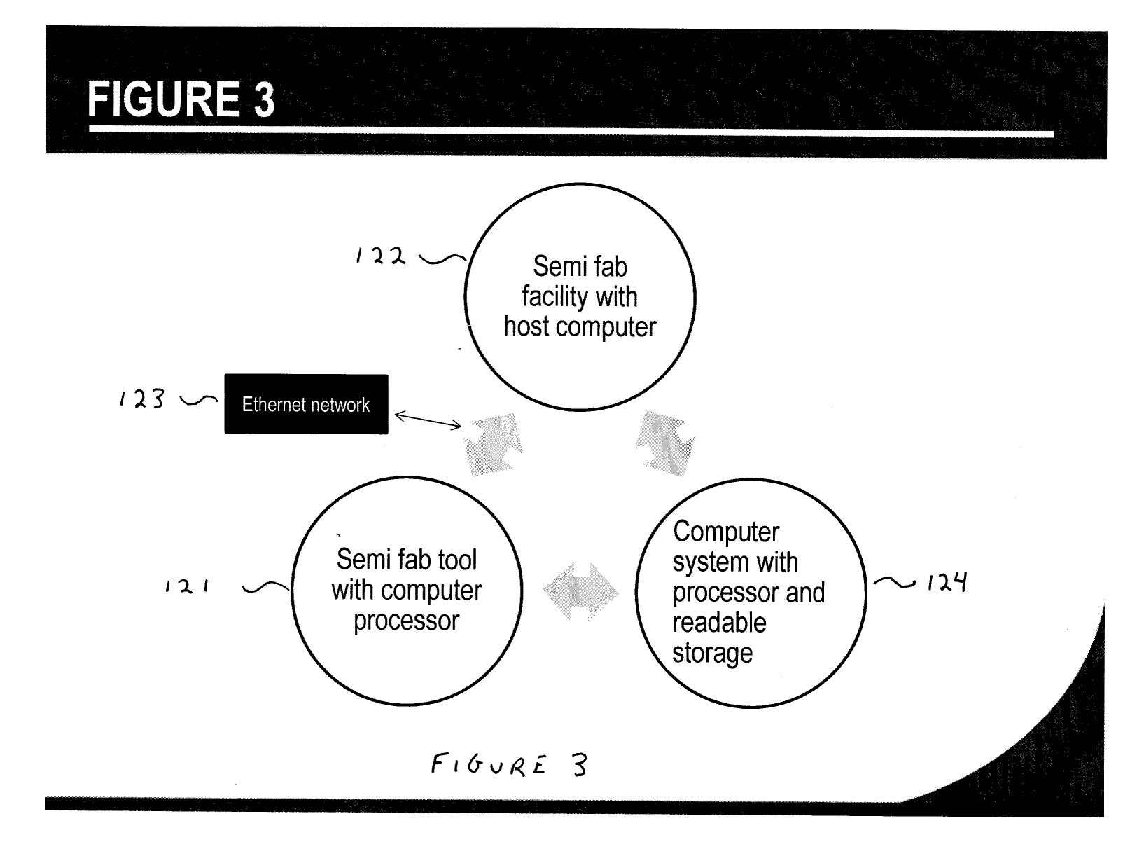

In accordance with certain embodiments, per FIG. 3, the system may further comprise a semiconductor fabrication tool including a processor 121; a semiconductor fabrication facility host computer 122; an Ethernet network in electronic communication with the processor and with the host computer of the semiconductor fabrication facility 123; and a computer system comprising a second processor and a computer readable storage medium 124.

An embodiment of a system in accordance with the present invention comprises that the MFC entity transmits to, receives or retrieves from, and/or processes data with another entity including but not limited to a computer, including hosted private or public, multi-tenant centralized servers, mobile devices, and other facilities or devices. In accordance with certain embodiments, the system may further comprise SEMI Equipment Communication Standard (SECS) compliant protocols, including factory host systems (e.g. host computer of the semiconductor fabrication facility as noted in the preceding paragraph).

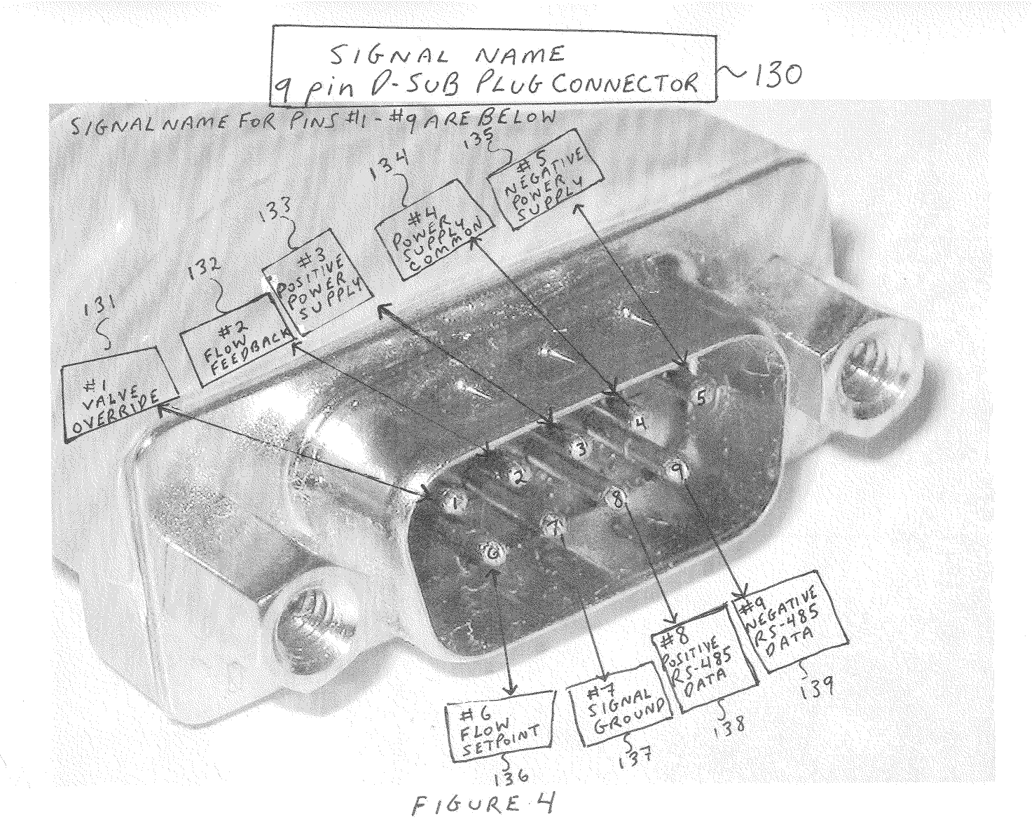

In accordance with certain embodiments, per FIG. 4, the Signal Names for the 9-pin D-SUB plug connector 130 are referenced as follows: #1 Valve Override 131, #2 Flow Feedback 132, #3 Positive Power Supply 133, #4 Power Supply Common 134, #5 Negative Power Supply 135, #6 Flow-Setpoint 136, #7 Signal Ground 137, #8 Positive RS-485 Data 138, #9 Negative RS-485 Data 139.

Various features and advantages of the embodiments of the present invention can be more fully appreciated with reference to the accompanying drawings, tables and related comments in Table 1.

What is claimed is:

1. A mass flow controller (MFC) that contains plugs, circuitry and software which are designed to handle multiple communication protocols including, but not limited to, analog, RS-485, and DeviceNet.

2. The system of claim 1, wherein communication of gas flow data is established between the MFC and at least one other entity.

3. The system of claim 2, wherein the other entity comprises a processor in a manufacturing tool. The system may further comprise a semiconductor fabrication tool including a processor; a semiconductor fabrication facility host computer; an Ethernet network in electronic communication with the processor and with the host computer of the semiconductor fabrication facility; and a computer system comprising a second processor and a computer readable storage medium.

4. The system of claim 2, further comprising that the MFC entity transmits to, receives or retrieves from, and/or processes data with another entity including but not limited to a computer, including hosted private or public, multi-tenant centralized servers, mobile devices, and other facilities or devices.

5. The system of claim 4, further comprising SEMI Equipment Communication Standard (SECS) compliant protocols, including factory host systems.

6. The system of claim 1 utilizes a pin configuration that is compatible between RS-485 and analog protocols, using a different connector plug for DeviceNet that operates independently from other protocols; incorporating all these configurations onto one MFC device, resulting in one MFC device handling multiple communication protocols.

7. The system of claim 1, wherein a 9-pin male D-Sub (a.k.a. DB9) connector of the MFC, operating in RS-485 with the allocation of respective 9 pins in FIG. 1 and Table 1, the MFC ignores pins two and six, and communicates via pins 8 and 9.

8. The system of claim 1, further comprising that in analog mode, pin 8, as well as pin 7 (per FIG. 2 and Table 1), are both ground. In this case, an adapter is used to connect pin 8 to pin 7. The MFC allows pin 8 to become ground in this case, making the MFC compatible with certain process tools that require pin 8 to be ground.
